(19) United States
(12) Patent Application Publication
(10) Pub. No.: US 2026/0261665 A1
(43) Pub. Date: Sep. 3, 2026

(54) STORING AND SIGNALING POST PROCESSING ORDER IN A HEADER

(71) Applicant: InterDigital CE Patent Holdings, SAS, Paris (FR)

(72) Inventors: Frederic Lefebvre, Rennes (FR); Guillaume Boisson, Pleumeleuc (FR); Fabrice Urban, Thorigne Fouillard (FR); Philippe Bordes, Laille (FR)

(73) Assignee: InterDigital CE Patent Holdings, SAS, Paris (FR)

(21) Appl. No.: 19/489,201

(22) PCT Filed: Jun. 10, 2024
(86) PCT No.: PCT/EP2024/065889

§ 371 Date: Dec. 1, 2025

(30) Foreign Application Priority Data
Jun. 29, 2023 (EP) 23306072.2

(51) Int. Cl. H04N 19/117; H04N 19/70; H04N 19/80

(52) U.S. Cl. CPC H04N 19/117; H04N 19/70; H04N 19/80

(57) ABSTRACT

Systems, methods, and instrumentalities are disclosed for storing a post processing order in dedicated code in a header of a region (e.g., a slice) and/or a picture. A video encoding and/or decoding device may include a processor configured to determine a post-filter order associated with a sub-region of a region or a picture. The post-filter order may be associated with at least two filters. The post-filter order may indicate a post-filter processing order. The device may send the post-filter order in a region header or a picture header. The device may generate a coding cost and/or a distortion. The coding cost and/or the distortion may be associated with the post-filter processing order.

### CROSS-REFERENCE TO RELATED APPLICATIONS

This application claims the benefit of European Provisional Patent Application No. 23306072.2, filed Jun. 29, 2023, the contents of which are hereby incorporated by reference herein.

### BACKGROUND

Video coding systems may be used to compress digital video signals, e.g., to reduce the storage and/or transmission bandwidth needed for such signals. Video coding systems may include, for example, block-based, wavelet-based, and/or object-based systems.

### SUMMARY

Systems, methods, and instrumentalities are disclosed for storing a post processing order in dedicated code in a header of a region or a picture. Signaling may be used to define a post-filter order. Signaling may specify an order at the encoder and decoder for post processing. A post processing order may be stored in a header. In examples, the post processing order may be stored in a header associated with a region or a slice, or in a picture header.

In examples, a video coding device may determine a post-filter order associated with a sub-region or a coding tree unit (CTU) of a region (or slice) or a picture. The post-filter order may indicate a post processing order. In an example, cross-component sample-adaptive offset (CCSAO) may be applied before sample adaptive offset (SAO). The post-filter order may be a luma post-filter order or a chroma post-filter order.

The video coding device may send the post-filter order in a region (or slice) header or a picture header. The video coding device may determine a luma post-filter order and apply the luma post-filter order to a chroma post-filter order. The luma post-filter order may be different than the chroma post-filter order.

The video coding device may determine the post-filter order based on (e.g., optimization of) a coding cost and a distortion. The video coding device may determine a rate distortion cost for each sub-region of a region when the post-filter order is sent in a region header. The video coding device may determine a rate distortion cost for each sub-region of a picture when the post-filter order is sent in a picture header. The video coding device may determine the rate distortion cost based on a distortion of a current block with its coding parameters, an associated rate or cost, and/or a parameter derived from a quantization parameter.

Systems, methods, and instrumentalities are disclosed for video encoding. A video encoding device may include a processor configured to determine a post-filter order associated with a sub-region of a region or a picture. The post-filter order may be associated with at least two filters. The post-filter order may indicate a post-filter processing order. The video encoding device may send the post-filter order in a region header or a picture header.

The video encoding device as described herein may include one or more features. In examples, the video encoding device may be configured to generate a coding cost and a distortion. The coding cost and the distortion may be associated with the post-filter processing order. The video encoding device may be configured to determine a luma post-filter order or a chroma post-filter order. The video encoding device may be configured to determine a luma post-filter order. The video encoding device may be configured to apply the luma post-filter order to a chroma post-filter order. In examples, the luma post-filter order may be different than the chroma post-filter order. The video encoding device may be configured to, when the post-filter order is to be sent to the region header, determine a rate distortion cost for the sub-region of the region.

The video encoding device may be configured to when the post-filter order is to be sent to the picture header, determine a rate distortion cost for a sub-region of the picture. The video encoding device may be configured to determine the rate distortion cost based on a distortion of a current block with the current block's coding parameters, an associated rate or cost, and/or a parameter derived from a quantization parameter. In examples, the sub-region may be a coding tree unit (CTU), the region may be a slice, and the region header may be a slice header. The at least two filters may include a sample-adaptive offset (SAO), a cross-component SAO (CCSAO), an adaptive loop filter, or a deblocking filter. The post-filter order may indicate that a CCSAO is to be applied before a SAO.

Systems, methods, and instrumentalities are disclosed for video decoding. A video decoding device may include a processor configured to determine a post-filter order associated with a sub-region of a region or a picture. The post-filter order may be associated with at least two filters. The post-filter order may indicate a post-filter processing order. The video decoding device may send the post-filter order in a region header or a picture header.

The video decoding device as described herein may include one or more features. In examples, the video decoding device may be configured to generate a coding cost and a distortion. The coding cost and the distortion may be associated with the post-filter processing order. The video decoding device may be configured to determine a luma post-filter order or a chroma post-filter order. The video decoding device may be configured to determine a luma post-filter order. The video decoding device may be configured to apply the luma post-filter order to a chroma post-filter order. In examples, the luma post-filter order may be different than the chroma post-filter order. The video decoding device may be configured to, when the post-filter order is to be sent to the region header, determine a rate distortion cost for the sub-region of the region.

The video decoding device may be configured to when the post-filter order is to be sent to the picture header, determine a rate distortion cost for a sub-region of the picture. The video decoding device may be configured to determine the rate distortion cost based on a distortion of a current block with the current block's coding parameters, an associated rate or cost, and a parameter derived from a quantization parameter. In examples, the sub-region may be a coding tree unit (CTU), the region may be a slice, and the region header may be a slice header. The at least two filters may include a sample-adaptive offset (SAO), a cross-component SAO (CCSAO), an adaptive loop filter, or a deblocking filter. The post-filter order may indicate that a CCSAO is to be applied before a SAO.

Systems, methods, and instrumentalities described herein may involve a decoder. In some examples, the systems, methods, and instrumentalities described herein may involve an encoder. In some examples, the systems, methods, and instrumentalities described herein may involve a signal (e.g., from an encoder and/or received by a decoder). A computer-readable medium may include instructions for causing one or more processors to perform methods described herein. A computer program product may include instructions which, when the program is executed by one or more processors, may cause the one or more processors to carry out the methods described herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example video encoder.

FIG. 3 illustrates an example video decoder.

FIG. 4 illustrates an example of a system in which various aspects and examples may be implemented.

FIGS. 5A-5C illustrate an example of determination of a reconstructed sample category in case of edge offset (EO) mode.

FIG. 6 illustrates an example of a pixel range uniformly split into multiple bands, for example, in case of band offset (BO) mode.

FIG. 7 illustrates an example of a modified sample adaptive offset (SAO) process when cross-component sample-adaptive offset (CCSAO), is applied.

FIG. 8 illustrates an example of candidate positions used for a CCSAO classifier.

FIG. 9 illustrates an example of joint clipping after adding SAO/bilateral filter (BIF)/CCSAO offsets to the input sample.

FIG. 10 illustrates an example of four one dimensional (1-D) directional patterns for CCSAO EO sample classification: horizontal, vertical, 135° diagonal, and 45° diagonal.

FIG. 11 illustrates an example of adaptive loop filter (ALF) filtering shapes.

FIGS. 12A-12D illustrate examples of subsampled positions for subsampled Laplacian calculations.

FIG. 13A illustrates an example of placement of CC-ALF with respect to other loop filters.

FIG. 13B illustrates an example of a diamond shaped filter.

FIG. 14 illustrates an example of a post processing filter order.

FIG. 15 illustrates an example of a post processing filter order.

### DETAILED DESCRIPTION

A more detailed understanding may be had from the following description, given by way of example in conjunction with the accompanying drawings.

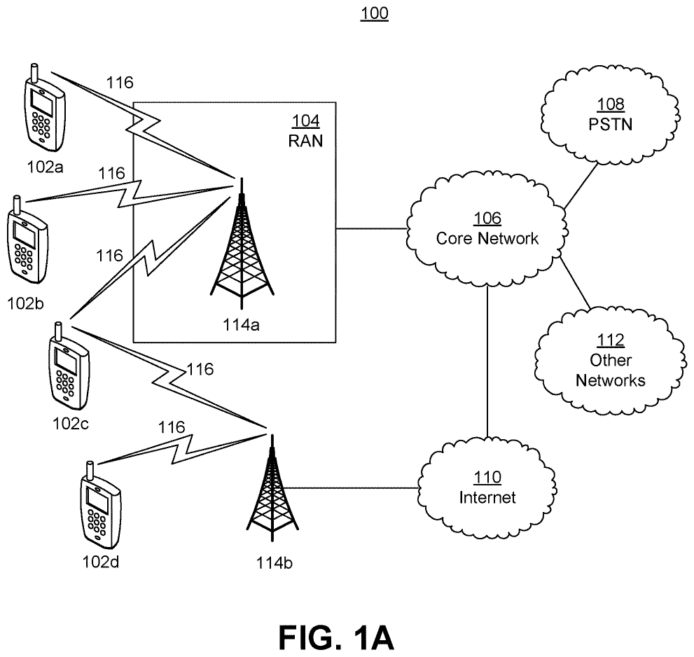

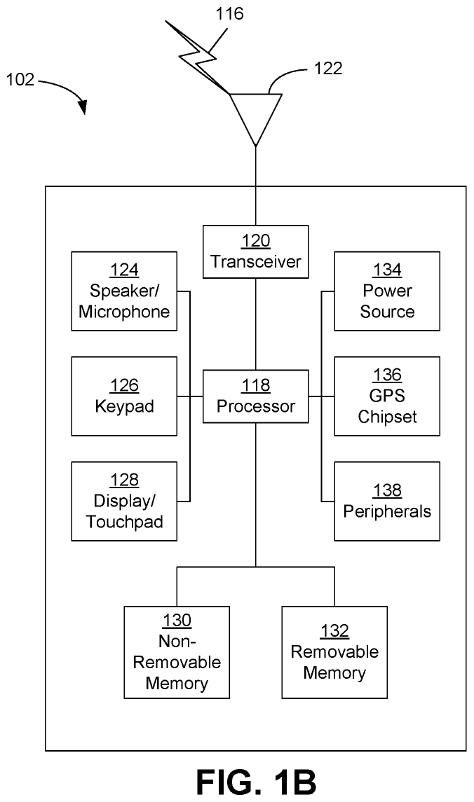

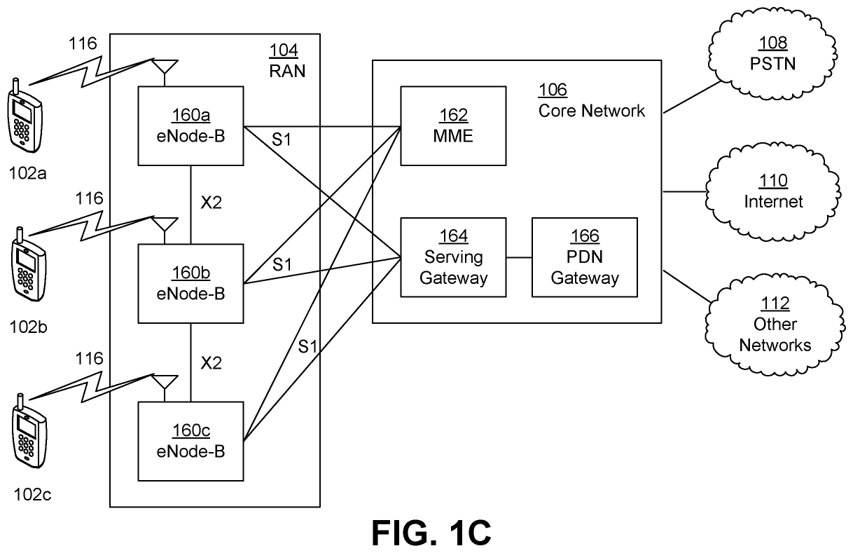

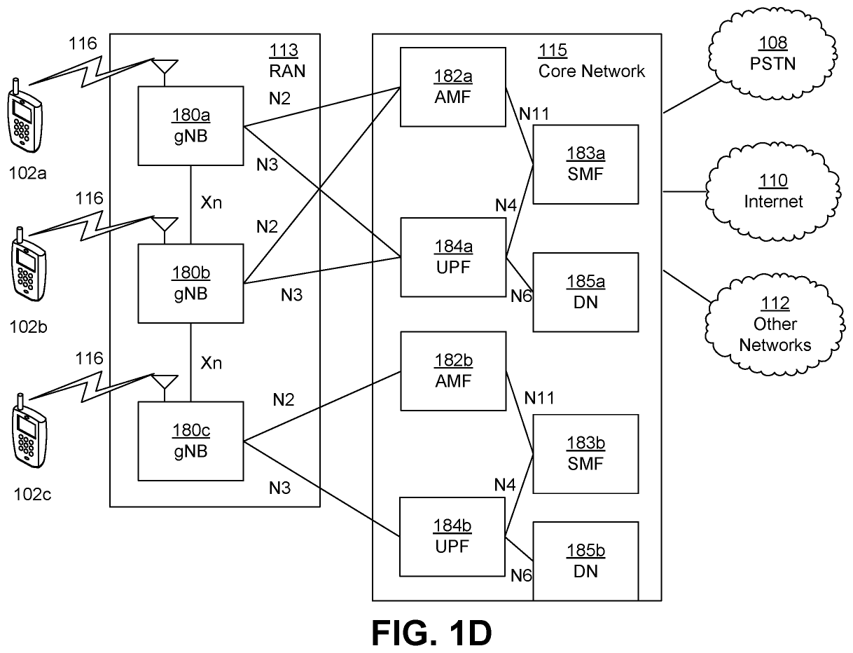

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

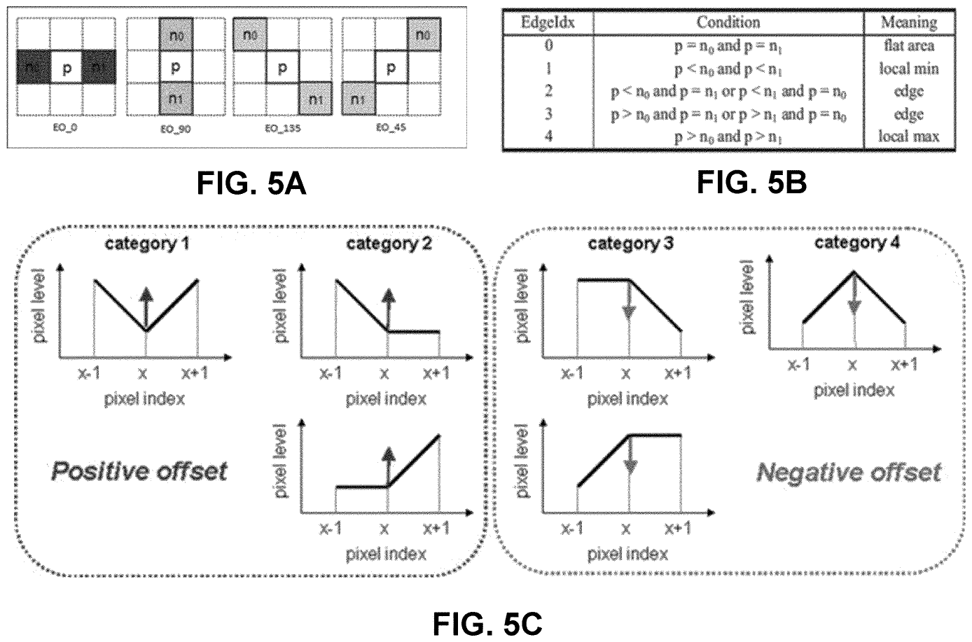

The aspects described and contemplated in this application may be implemented in many different forms. FIG. 5A to FIG. 15 described herein may provide some examples, but other examples are contemplated. The discussion of FIG. 5A to FIG. 15 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

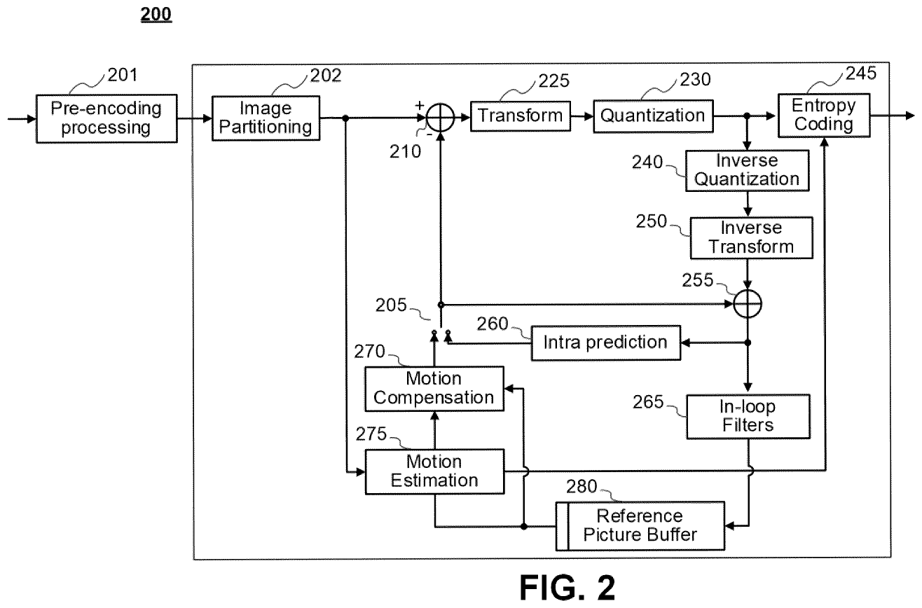

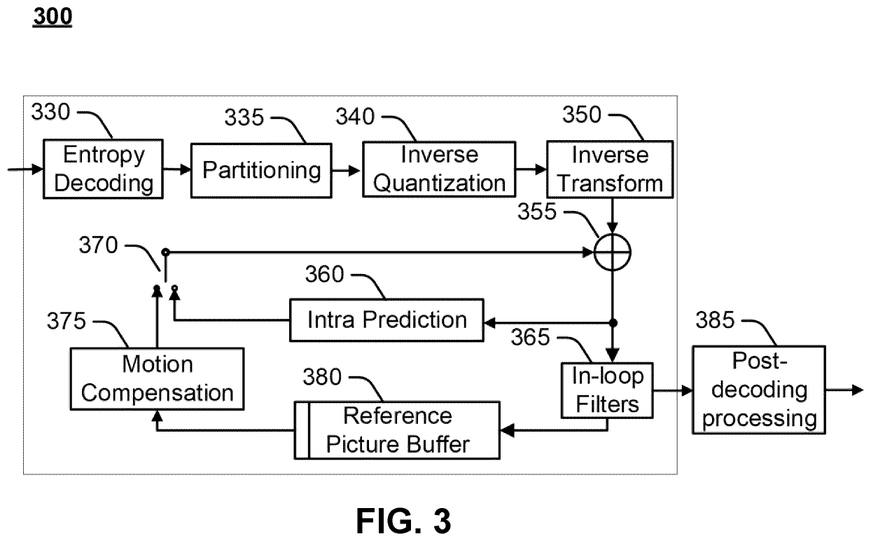

Various methods and other aspects described in this application may be used to modify modules, for example, decoding modules, of a video encoder 200 and decoder 300 as shown in FIG. 2 and FIG. 3. Moreover, the subject matter disclosed herein may be applied, for example, to any type, format or version of video coding, whether described in a standard or a recommendation, whether pre-existing or future-developed, and extensions of any such standards and recommendations. Unless indicated otherwise, or technically precluded, the aspects described in this application may be used individually or in combination.

Various numeric values are used in examples described the present application, such as degree values, a number of SAO modes, a number of CCSAO modes, offset values, range values, minimum values, maximum values, a number of categories, a number of bits, flag values, a block size, a number of filters, a post filter size, a number of bands, Golomb code for a post filter order, number of dimensions, a number of columns, a number of samples, a number of candidates, an order, a number of positions, constant values in formulas, subsample sizes, filter coefficient values, power values, exponent values, etc. These and other specific values are for purposes of describing examples and the aspects described are not limited to these specific values.

FIG. 2 is a diagram showing an example video encoder (e.g., a block-based hybrid video encoder). Variations of example encoder 200 are contemplated, but the encoder 200 is described below for purposes of clarity without describing all expected variations.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing, and attached to the bitstream.

In the encoder 200, a picture is encoded by the encoder elements as described below. The picture to be encoded is partitioned (202) and processed in units of, for example, coding units (CUs). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, such as picture partitioning information, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform (e.g., post-processing in a predefined order), for example, deblocking/SAO (Sample Adaptive Offset)/CCSAO (Cross Component Sample Adaptive Offset)/ALF (Adaptive Loop Filter) filtering to reduce encoding artifacts. The filtered image is stored at a reference picture buffer (280).

FIG. 3 is a diagram showing an example of a video decoder. In example decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which may be generated by video encoder 200. The bitstream is first entropy decoded (330) to obtain transform coefficients, prediction modes, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block may be obtained (370) from intra prediction (360) or motion-compensated prediction (i.e., inter prediction) (375). In-loop filters (365) are applied to the reconstructed image. The filtered image is stored at a reference picture buffer (380). In some examples (e.g., for a given picture) the contents of the reference picture buffer 380 on the decoder 300 side may be identical to the contents of the reference picture buffer 280 on the encoder 200 side (e.g., for the same picture).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream. In an example, the decoded images (e.g., after application of the in-loop filters (365) and/or after post-decoding processing (385), if post-decoding processing is used) may be sent to a display device for rendering to a user.

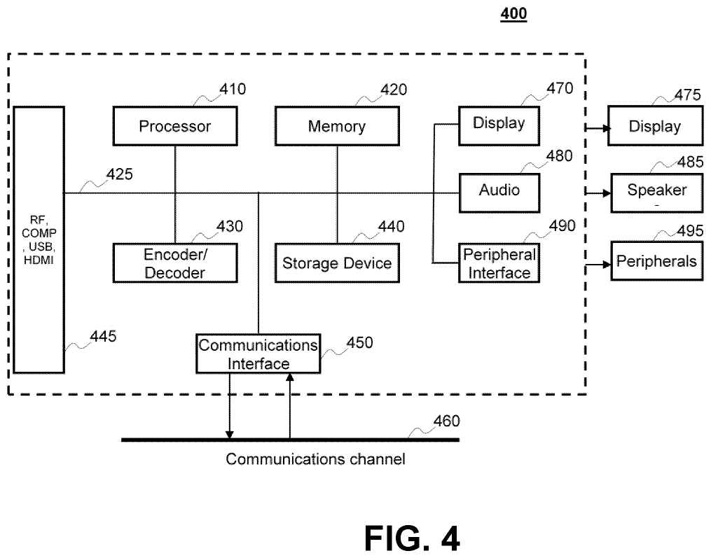

FIG. 4 is a diagram showing an example of a system in which various aspects and examples described herein may be implemented. System 400 may be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various examples, the system 400 is communicatively coupled to one or more other systems, or other electronic devices, via, for example, a communications bus or through dedicated input and/or output ports. In various examples, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that may be included in a device to perform the encoding and/or decoding functions. As is known, a device can include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various examples, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some examples, memory inside of the processor 410 and/or the encoder/decoder module 430 is used to store instructions and to provide working memory for processing that is needed during encoding or decoding. In other examples, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several examples, an external non-volatile flash memory is used to store the operating system of, for example, a television. In at least one example, a fast external dynamic volatile memory such as a RAM is used as working memory for video encoding and decoding operations.

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various examples, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which may be referred to as a channel in certain examples, (iv) demodulating the downconverted and band-limited signal, (v) performing error correction, and/or (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box example, the RF portion and its associated input processing element receives an RF signal transmitted over a wired (for example, cable) medium, and performs frequency selection by filtering, downconverting, and filtering again to a desired frequency band. Various examples rearrange the order of the above-described (and other) elements, remove some of these elements, and/or add other elements performing similar or different functions. Adding elements can include inserting elements in between existing elements, such as, for example, inserting amplifiers and an analog-to-digital converter. In various examples, the RF portion includes an antenna.

The USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the datastream as necessary for presentation on an output device.

Various elements of system 400 may be provided within an integrated housing, Within the integrated housing, the various elements may be interconnected and transmit data therebetween using suitable connection arrangement 425, for example, an internal bus as known in the art, including the Inter-IC (12C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 may be implemented, for example, within a wired and/or a wireless medium.

Data is streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these examples is typically connected to an access point or router that provides access to external networks including the Internet for allowing streaming applications and other over-the-top communications. Other examples provide streamed data to the system 400 using a set-top box that delivers the data over the HDMI connection of the input block 445. Still other examples provide streamed data to the system 400 using the RF connection of the input block 445. As indicated above, various examples provide data in a non-streaming manner. Additionally, various examples use wireless networks other than Wi-Fi, for example a cellular network or a Bluetooth® network.

The system 400 can provide an output signal to various output devices, including a display 475, speakers 485, and other peripheral devices 495. The display 475 of various examples includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 can also be integrated with other components (for example, as in a smart phone), or separate (for example, an external monitor for a laptop). The other peripheral devices 495 include, in various examples, one or more of a stand-alone digital video disc (or digital versatile disc) (DVD, for both terms), a disk player, a stereo system, and/or a lighting system. Various examples use one or more peripheral devices 495 that provide a function based on the output of the system 400. For example, a disk player performs the function of playing the output of the system 400.

In various examples, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various examples, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various examples in which the display 475 and speakers 485 are external components, the output signal may be provided via dedicated output connections, including, for example, HDMI ports, USB ports, or COMP outputs.

The examples may be carried out by computer software implemented by the processor 410 or by hardware, or by a combination of hardware and software. As a non-limiting example, the examples may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding. In various examples, such processes also, or alternatively, include processes performed by a decoder of various implementations described in this application, for example, determining a post-filter order associated with a sub-region (e.g., a coding tree unit (CTU)) of a region (e.g., a slice) or a picture, wherein the post-filter order indicates a post processing order, receiving the post-filter order in a slice header or a picture header, determining a luma post-filter order or a chroma post-filter order, determining a luma post-filter order and applying the luma post-filter order to a chroma post-filter order, generating a coding cost and a distortion, determining a rate distortion cost for each CTU of a slice when configured to receive the post-filter order in slice header, determining a rate distortion cost for each CTU of a picture when configured to receive the post-filter order in a picture header, determining the rate distortion cost based on a distortion of a current block with its coding parameters, an associated rate or cost, and/or a parameter derived from a quantization parameter, etc.

As further examples, in one example “decoding” refers only to entropy decoding, in another example “decoding” refers only to differential decoding, and in another example “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various examples, such processes include one or more of the processes typically performed by an encoder, for example, partitioning, differential encoding, transformation, quantization, and entropy encoding. In various examples, such processes also, or alternatively, include processes performed by an encoder of various implementations described in this application, for example, determining a post-filter order associated with a sub-region (e.g., a coding tree unit (CTU)) of a region (e.g., a slice) or a picture, wherein the post-filter order indicates a post processing order, sending the post-filter order in a region header (e.g., a slice header) or a picture header, determining a luma post-filter order or a chroma post-filter order, determining a luma post-filter order and applying the luma post-filter order to a chroma post-filter order, generating a coding cost and a distortion, determining a rate distortion cost for each CTU of a slice when configured to send the post-filter order in slice header, determining a rate distortion cost for each CTU of a picture when configured to send the post-filter order in a picture header, determining the rate distortion cost based on a distortion of a current block with its coding parameters, an associated rate or cost, and/or a parameter derived from a quantization parameter, etc.

As further examples, in one example “encoding” refers only to entropy encoding, in another example “encoding” refers only to differential encoding, and in another example “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein, such as ph_postproc_order, rdo_postprocessing_order_picture( ), sps_sao_enabled_flag, pps_sao_info_in_ph_flag, ph_sao_luma_enabled_flag, sps_ccsao_enabled_flag, ph_cc_sao_y_enabled_flag, pps_dbf_info_in_ph_flag, ph_deblocking_params_present_flag, sps_alf_enabled_flag, pps_alf_info_in_ph_flag, ph_alf_enabled_flag, etc., as may be recited in example logic, algorithms, equations, and so on, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation”, as well any other variations, appearing in various places throughout this application are not necessarily all referring to the same example.

Additionally, this application may refer to “determining” various pieces of information. Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. Encoder signals may include, for example, current parameters, such as offsets, flags, indices, and filter parameters, including a post-filter order (e.g., rdo_postprocessing_order_slice, rdo_postprocessing_order_picture), that may be signaled at various levels (e.g., picture header, region or slice header, sub-region or CTU, APS), etc. In this way, in an example the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling may be used without transmitting (implicit signaling) to simply allow the decoder to know and select the particular parameter. By avoiding transmission of any actual functions, a bit savings is realized in various examples. It is to be appreciated that signaling may be accomplished in a variety of ways. For example, one or more syntax elements, flags, and so forth are used to signal information to a corresponding decoder in various examples. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described example. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on, or accessed or received from, a processor-readable medium.

Many examples are described herein. Features of examples may be provided alone or in any combination, across various claim categories and types. Further, examples may include one or more of the features, devices, or aspects described herein, alone or in any combination, across various claim categories and types. For example, features described herein may be implemented in a bitstream or signal that includes information generated as described herein. The information may allow a decoder to decode a bitstream, the encoder, bitstream, and/or decoder according to any of the embodiments described. For example, features described herein may be implemented by creating and/or transmitting and/or receiving and/or decoding a bitstream or signal. For example, features described herein may be implemented a method, process, apparatus, medium storing instructions, medium storing data, or signal. For example, features described herein may be implemented by a TV, set-top box, cell phone, tablet, or other electronic device that performs decoding. The TV, set-top box, cell phone, tablet, or other electronic device may display (e.g. using a monitor, screen, or other type of display) a resulting image (e.g., an image from residual reconstruction of the video bitstream). The TV, set-top box, cell phone, tablet, or other electronic device may receive a signal including an encoded image and perform decoding.

As described herein, storing a post processing order in dedicated code in a header of a slice/picture may relate to in-loop filters, e.g., corresponding to 265 at encoder side in FIGS. 2 and 365 at decoder side in FIG. 3. Storing a post processing order in dedicated code in a header of a region (e.g., a slice) and/or a picture may relate to deblock filtering, cross-component sample-adaptive offsets (CCSAO), e.g., as an extension of sample-adaptive offsets (SAO) and/or adaptive loop filtering (ALF). The terms region and slice may be used interchangeably.

Block-based intra/inter prediction and transform coding, e.g., together with quantization, may induce a variety of artifacts at medium and/or low bitrates, such as blocking artifacts, ringing artifacts, and/or color biases. Video coding, such as HEVC and VVC, may implement in-loop filters (e.g., sample-adaptive offset (SAO) and cross-component sample-adaptive offset (CCSAO)), for example, to reduce the artifacts. History-based CCSAO may be implemented (e.g., in an enhanced encoding model (ECM)), for example, to benefit from parameter sets that may be efficient in previously encoded/decoded slices. The current parameters may be encoded and signaled in a header, such as the picture header, region or slice header, sub-region or coding tree level (CTU), or adaptation parameter set (APS). The terms sub-region and CTU may be used interchangeably.

There may or may not be an optimized order of post filters. In some examples, a post filter order may be fixed. A process/algorithm may or may not search for and/or find a better order that performs the rate distortion.

Storing a post processing order in dedicated code in a header of a slice/picture, as described herein, may provide an indication (e.g., signaling) that defines a post-filter order. An indication may specify an order (e.g., the right order) at the encoder and decoder for the post processing.

Sample-adaptive offset (SAO) may be implemented, e.g., in HEVC. SAO may be used to reduce mean sample distortion of a region, for example, by (e.g., first) classifying the region samples into multiple categories with a (e.g., selected) classifier, obtaining an offset for a (e.g., each) category, and (e.g., then) adding the offset to the (e.g., each) sample of the category. The classifier index and/or the offsets of the region may be coded in the bitstream. In SAO, offsets and/or parameters may be signaled at the CTU level.

SAO may be implemented, e.g., in HEVC and VVCA. SAO may be implemented the same in WC and HEVC.

The coding tree unit (CTU) (e.g., when enabled) may be coded with multiple (e.g., three (3)) SAO modes (SaoTypeIdx), such as inactive (OFF), edge offset (EO), and/or band offset (BO). A (e.g., one) set of parameters per channel (Y,U,V) may be coded, for example, in case of EO or BO. The set of parameters may be shared with neighboring CTUs (e.g., SAO MERGE flag). The SAO mode may be the same for Cb and Cr components.

FIGS. 5A-5C illustrate an example determination of a reconstructed sample category in case of EO mode. A (e.g., each) reconstructed sample may be classified into multiple (e.g., NC=5) categories (e.g., sao_eo_class), for example, in case of EO. The category(ies) classification may depend on the local gradients following a (e.g., one) direction signaled per CTU (e.g., EO_0, EO_90, EO_135, or EO_45 corresponding to directions zero deg., 90 deg., 135 deg. or 45 deg.), as depicted by example in FIG. 5A-5C. A number (e.g., NC−1) offset values may be coded, for example, one for each category, e.g., where one category may have an offset equal to zero. The offset sign may be derived (e.g., implicitly derived) from the category.

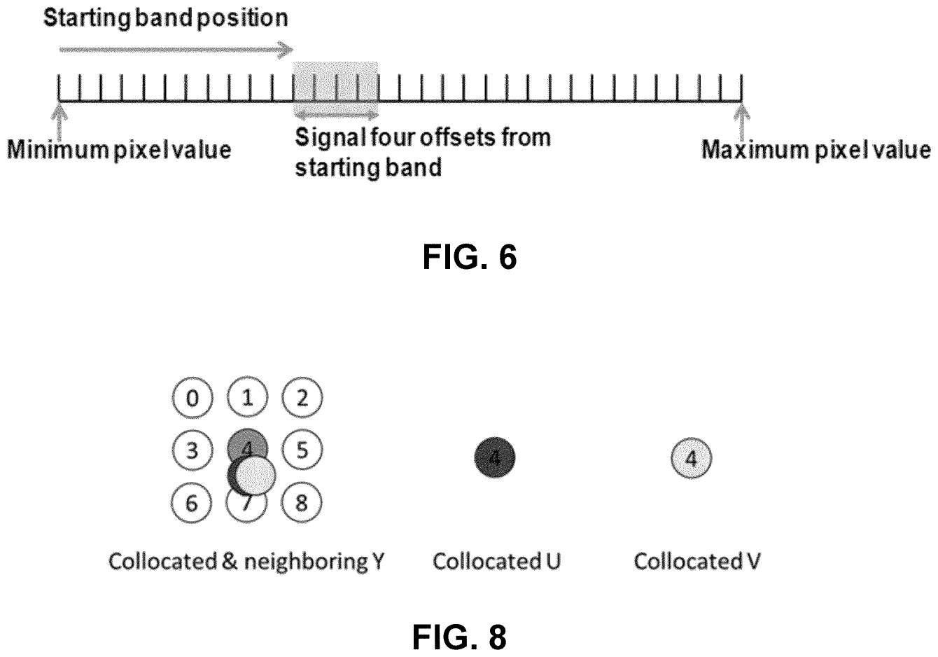

FIG. 6 depicts a pixel range that may be uniformly split into multiple (e.g., 32) bands, for example, in case of BO mode. For example, the pixel range split uniformly may be from 0 . . . 255 (e.g., in 8-bits). In an example, a sample range of values for component ‘c’ (e.g., 0 . . . 255, in 8-bits) may be split (e.g., uniformly split) into multiple (e.g., N(c)=32) bands, for example, in case of BO. Sample values belonging to multiple (e.g., (NC−1)=4) consecutive bands may be modified, for example, by adding an offset, off(n). FIG. 6 shows an example of four (4) consecutive bands. Signed offset values (e.g., (NC−1) signed offset values) and/or the starting band may be coded, for example, one for each of the (NC−1) bands, where the remaining bands may have an offset equal to zero.

A look-up table (LUT) ‘lut_{SAO}[c]’ including offsets for each band may be built for a (e.g., each) component ‘c’. The LUT may include zero, e.g., except for the NC-1 consecutives that include offsets to be added to the reconstructed samples, for example, in accordance with Eq. (1):

$$\begin{matrix}( 1 ) & \\ r e {c}_{SAO} [ x ] = r e c [ x ] + {lut}_{SAO} [ c ] [ r e c [ x ] >> s ] & ( 1 )\end{matrix}$$

With reference to Eq. (1), parameter rec[x] may be the reconstructed samples at position ‘x’ for the current component(c) (e.g., before applying SAO). Parameter s may be equal to (BD(c)−5), where BD(c) may be the bit-depth of the component ‘c’. Parameter lut_{SAO}[c] may include the offsets for the component ‘c’.

The SAO mode and/or offsets may not be coded, for example, in case of EO or BO. The SAO mode and/or offsets may be copied from the neighboring above or left CTU (e.g., in a merge mode).

SAO flags may be transmitted and/or signaled, for example, as described herein. A picture parameter set (PPS) may be transmitted and/or signaled, for example, in accordance with the following logic:

If !pps_no_pic_partition_flag
pps_sao_info_in_ph_flag

A sequence parameter set (SPS) may be transmitted and/or signaled, for example, in accordance with the following logic:

sps_sao_enabled_{—}

A picture header may be transmitted and/or signaled, for example, in accordance with the following logic:

```
if sps_sao_enabled_flag && pps_sao_info_in_ph_flag
  ph_sao_luma_enabled_flag
    if Chroma format != 400:
      ph_sao_chroma_enabled_flag
```

A slice header may be transmitted and/or signaled, for example, in accordance with the following logic:

```
if pps_sao_info_in_ph_flag && !sps_sao_enabled_flag
  slice_sao_luma_flag
  if chroma enable:
    slice_sao_chroma_flag
```

The flag pps_no_pic_partition_flag (e.g., equal to 1) may specify that no picture partitioning is applied to a (e.g., each) picture referring to the PPS. The flag pps_no_pic_partition_flag (e.g., equal to 0) may specify that a (e.g., each) picture referring to the PPS might be partitioned into more than one tile or slice.

The flag pps_sao_info_in_ph_flag (e.g., equal to 1) may specify that SAO filter information could be present in the PH syntax structure and/or not present in slice headers referring to the PPS that do not contain a PH syntax structure. The flag pps_sao_info_in_ph_flag (e.g., equal to 0) may specify that SAO filter information is not present in the PH syntax structure and/or could be present in slice headers referring to the PPS. The value of flag pps_sao_info_in_ph_flag may be inferred (e.g., to be equal to 0), for example, when flag pps_sao_info_in_ph_flag is not present.

The picture parameter set (PPS) may be a syntax structure, which may include syntax elements that apply to zero or more entire coded pictures, for example, as determined by a syntax element found in a (e.g., each) picture header.

The flag sps_sao_enabled_flag (e.g., equal to 1) may specify that SAO is enabled for the coded layer video sequence. The flag sps_sao_enabled_flag (e.g., equal to 0) may specify that SAO is disabled for the coded layer video sequence.

The sequence parameter set (SPS) may be a syntax structure including syntax elements that apply to zero or more entire coded layer video sequences, for example, as determined by the content of a syntax element found in the PPS referred to by a syntax element found in a (e.g., each) picture header.

The flag ph_sao_luma_enabled_flag (e.g., equal to 1) may specify that SAO is enabled for the luma component of the current picture. The flag ph_sao_luma_enabled_flag (e.g., equal to 0) may specify that SAO is disabled for the luma component of the current picture. The flag ph_sao_luma_enabled_flag may be inferred (e.g., to be equal to 0), for example, when the flag ph_sao_luma_enabled_flag is not present.

The flag ph_sao_chroma_enabled_flag (e.g., equal to 1) may specify that SAO is enabled for the chroma component of the current picture. The flag ph_sao_chroma_enabled_flag (e.g., equal to 0) may specify that SAO is disabled for the chroma component of the current picture. The flag ph_sao_chroma_enabled_flag may be inferred (e.g., to be equal to 0), for example, when the flag ph_sao_chroma_enabled_flag is not present.

The flag slice_sao_luma_flag (e.g., equal to 1) may specify that SAO is used for the luma component in the current slice. The flag slice_sao_luma_flag (e.g., equal to 0) may specify that SAO is not used for the luma component in the current slice.

The flag slice_sao_chroma_flag (e.g., equal to 1) may specify that SAO is used for the chroma component in the current slice. The flag slice_sao_chroma_flag (e.g., equal to 0) may specify that SAO is not used for the chroma component in the current slice.

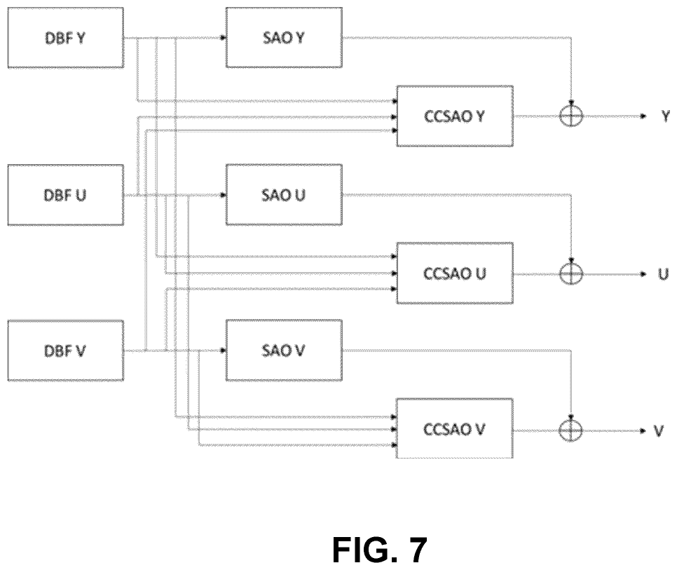

FIG. 7 is a diagram illustrating an example of a decoding workflow (e.g., a modified SAO process when the CCSAO is applied.) Cross-component sample-adaptive offset (CCSAO) may be implemented, for example, in ECM. CCSAO may be used to refine reconstructed chroma samples. CCSAO may (e.g., similarly to SAO) classify the reconstructed samples into different categories. CCSAO may derive an (e.g., one) offset for a (e.g., each) category. CCSAO may add the offset to the reconstructed samples in the category for which CCSAO derived the offset. CCSAO may differ from SAO. SAO may use (e.g., only) one (e.g., a single) luma/chroma component of current sample as input. CCSAO may utilize multiple (e.g., all three) components to classify the current sample into different categories. Output samples from the de-blocking filter may be used as the input of the CCSAO, e.g., to facilitate the parallel processing.

CCSAO may use (e.g., only) BO to enhance the quality of the reconstructed samples. For a given luma/chroma sample, multiple (e.g., three) candidate samples may be selected to classify the given sample into different categories, such as a (e.g., one) collocated Y sample, a (e.g., one) collocated U sample, and a (e.g., one) collocated V sample. The sample values of the (e.g., three) selected samples may be classified into (e.g., three) different bands, e.g., {band_{Y}, band_{U}, band_{V}}. A joint index i may represent the category of the given sample. An (e.g., one) offset may be signaled for (e.g., and added to) the reconstructed samples that fall into the category, which may be formulated/implemented in accordance with a set of equations, e.g., as shown in Eq. (2)-Eq. (6):

$${band}_{Y} = ( {Y}_{c o l} \cdot {N}_{Y} ) >> BD \qquad ( 2 )$$

$${band}_{U} = ( {U}_{c o l} \cdot {N}_{U} ) >> BD \qquad ( 3 )$$

$${band}_{V} = ( {V}_{c o l} \cdot {N}_{V} ) >> BD \qquad ( 4 )$$

$$i = {band}_{Y} \cdot ( {N}_{U} \cdot {N}_{V} ) + {band}_{U} \cdot {N}_{V} + {band}_{V} \qquad ( 5 )$$

$${C}_{r e c}^{′} = Clip 1 ( {C}_{r e c} + {σ}_{C C S A O} [ i ] ) \qquad ( 6 )$$

With reference to Eq. (2)-Eq. (6), {Y_{col}, U_{col}, V_{col}} may be the three selected collocated samples used to classify current sample; {N_{Y}, N_{U}, N_{V}} may be the numbers of equally divided bands applied to {Y_{col}, U_{col}, V_{col}} full range, respectively; BD may be the internal coding bit-depth; C_{rec} and C′_{rec} may be the reconstructed samples before and after the CCSAO is applied; and σ_{CCSAO} [i] may be the value of the CCSAO offset applied to i-th BO category. The collocated luma sample may be chosen from multiple (e.g., nine (9)) candidate positions. The collocated chroma sample positions may be fixed, for example, as depicted by example in FIG. 8.

FIG. 8 illustrates an example of candidate positions used for a CCSAO classifier. CCSAO may apply different classifiers to various local regions, for example, to further enhance the (e.g., whole) picture quality. The parameters for a (e.g., each) classifier (e.g., the position of Y_{col}, N_{Y}, N_{U}, N_{V}, and offsets) may be signaled at picture level. The classifier to be used may be (e.g., explicitly) signaled and/or switched at CTB level. A maximum of {N_{Y}, N_{U}, N_{V}} may be set for a (e.g., each) classifier, for example, to {16, 4, 4} and/or offsets may be constrained to be within a range, such as [−15, 15]. In some examples, at most four (4) classifiers may be used per frame.

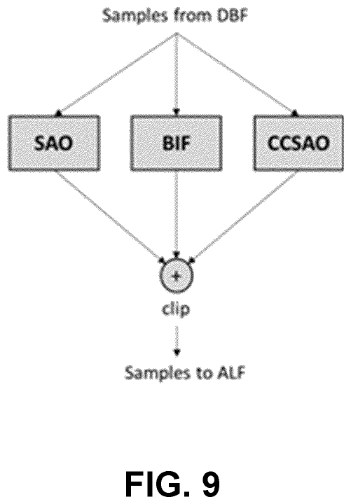

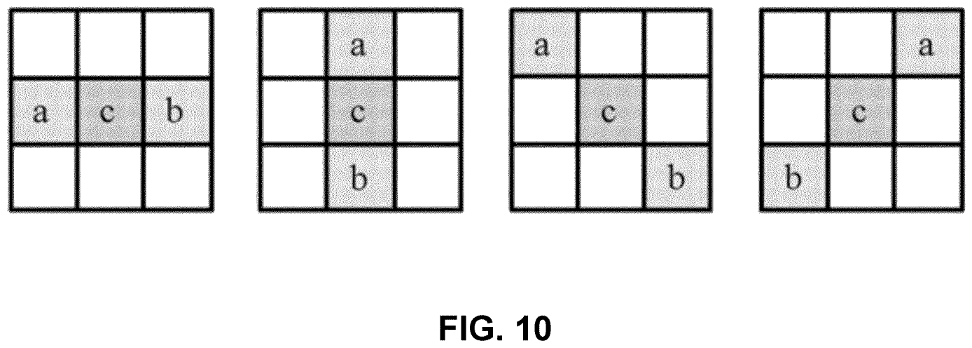

FIG. 9 is a diagram illustrating an example of joint clipping after adding SAO/BIF/CCSAO offsets to the input sample. In some examples, SAO, bilateral filter (BIF), and/or CCSAO offset may be computed in parallel, added to the reconstructed chroma samples, and jointly clipped, as depicted in FIG. 9. An edge-based classifier of CCSAO may (e.g., similar to an edge classifier of SAO in VVC) use four one-dimensional (1-D) directional patterns for sample classification, e.g., horizontal, vertical, 135° diagonal, and 45° diagonal (e.g., as illustrated in an example of FIG. 10).

FIG. 10 illustrates an example of four 1-D directional patterns for CCSAO EO sample classification: horizontal (EO class=0), vertical (EO class=1), 135° diagonal, and 45° diagonal. As shown by example in FIG. 10, a (e.g., each) sample may be classified for a (e.g., every) 1-D pattern based on, for example, the sample difference between the luma sample value labeled as “c” and two neighbor luma samples labeled as “a” and “b” along the selected 1-D pattern.

CCSAO may (e.g., similar to SAO) involve the encoder deciding a (e.g., the best) 1-D directional pattern using rate-distortion optimization (RDO). The encoder may signal the additional information in a (e.g., each) classifier/set. The sample differences “a−c” and “b−c” may be compared against a (e.g., pre-defined) threshold value (Th) to derive the (e.g., final) “class_idx” information.

The encoder may select a (e.g., the best) “Th” value from an array of pre-defined threshold values, for example, based on RDO. The index into the “Th” array may be signaled. There may be a difference (e.g., an additional difference) between a CCSAO edge-based classifier and an SAO edge classifier, e.g., in WC. For example, chroma samples in CCSAO may use co-located luma samples for deriving edge information (e.g., samples “a,” “c,” and “b” may be the co-located luma samples). Chroma samples in SAO may use their own neighboring samples for deriving the edge information.

An edge-based classifier process may be formulated/implemented in accordance with a set of equations, for example, as shown in Eq. (7)-Eq. (10):

$$Ea = ( a - c < 0 ) ? ( a - c < ( - Th ) ? 0 : 1 ) : ( a - c < ( Th ) ? 2 : 3 ) \qquad ( 7 )$$

$$Eb = ( b - c < 0 ) ? ( b - c < ( - Th ) ? 0 : 1 ) : ( b - c < ( Th ) ? 2 : 3 ) \qquad ( 8 )$$

$$class\_idx = {i}_{B} * 16 + Ea * 4 + Eb \qquad ( 9 )$$

$${C}_{rec}^{′} = Clip 1 ( {C}_{rec} + {σ}_{CCSAO} [ class\_idx ] ) \qquad ( 10 )$$

With reference to Eq. (3C), variable “i_{B}” may be derived, for example, in accordance with Eq. (11):

$$( 11 )$$

$${i}_{B} = ( cur \cdot {N}_{cur} ) >> BD ( or ) {i}_{B} = ( col 1 \cdot {N}_{col 1} ) >> BD ( or ) {i}_{B} = ( col 2 \cdot {N}_{col 2} ) >> BD$$

The current sample “cur” may be the current sample being processed. Parameters col1 and col2 may be co-located samples. Parameters col1 and col2 may be co-located C_{b} and Cᵣ samples, respectively, when Luma samples are processed. Parameters col1 and col2 may be the co-located Y and Cᵣ samples respectively, when Chroma(C_{b}) samples are processed. Parameters col1 and col2 may be the co-located Y and C_{b} samples respectively, when Chroma(Cᵣ)samples are processed.

Encoder signals (e.g., one among the samples “cur,” “col1,” “col2”) may be used in deriving the band information, for example, based on RDO.

CCSAO offsets and/or parameters may be transmitted. For example, parameters and/or flags may be transmitted and/or signaled as disclosed herein.

SPS may be transmitted and/or signaled using a flag, for example,

sps_ccsao_enabled_flag

Picture Header may be transmitted and/or signaled in accordance with the following:
if sps_ccsao_enabled_flag enable Flag && “SAO Info in Picture Header” Flag:

ph_cc_sao_y_enabled_flag
ph_cc_sao_cr_enabled_flag
ph_cc_sao_cb_enabled_flag

Slice Header may be transmitted and/or signaled in accordance with the following:

```
if sps_ccsao_enabled_flag enable
  slice_ccsao_y_enabled_flag
  slice_ccsao_cr_enabled_flag
  slice_ccsao_cb_enabled_flag
```

For example, for a (e.g., each) component Y,Cr,Cb:

| | |
|---|---|
| if | slice_ccsao_y/cr/cb_enabled_flag enable |
| | ccsao_set_num |
| | For setIdx < ccsao_set_num: |
| | setType[setIdx] Flag |
| | if setType[setIdx]=edge: |
| | ccsao_cand_pos_y |
| | ccsao_band_num_y |
| | ccsao_band_num_c |
| | else |
| | ccsao_cand_pos_y |
| | ccsao_band_num_y |
| | ccsao_band_num_u |
| | ccsao_band_num_v |
| | ccsao_offset_abs |
| | ccsao_offset_sign |

Parameter sps_ccsao_enabled_flag may be a flag that specifies that SPS CCSAO is enabled (e.g., equal to 1). Parameter ph_cc_sao_y_enabled_flag may be a flag that specifies that Picture Header CCSAO is enabled (e.g., equal to 1) in Luma. Parameter ph_cc_sao_cr_enabled_flag may be a flag that specifies that Picture Header CCSAO is enabled (e.g., equal to 1) in Cᵣ. Parameter ph_cc_sao_cb_enabled_flag may be a flag that specifies that Picture Header CCSAO is enabled (e.g., equal to 1) in Cb. Parameter slice_ccsao_y_enabled_flag may be a flag that specifies that Slice CCSAO is enabled (e.g., equal to 1) in Y. Parameter slice_ccsao_cr_enabled_flag may be a flag that specifies that Slice CCSAO is enabled (e.g., equal to 1) in Cᵣ. Parameter slice_ccsao_cb_enabled_flag may be a flag that specifies that Slice CCSAO is enabled (e.g., equal to 1) in Cb. Parameter ccsao_set_num may be a number of sets enabled. In some examples, a maximum number of sets may be indicated (e.g., MAX_CCSAO_SET_NUM=4). Parameter setType may be a flag that specifies that offset type is edge (e.g., equal to 1) or Band (e.g., equal to 0). Parameter ccsao_cand_pos may be assigned a value that specifies a (e.g., the best) candidate position y among the (e.g., nine (9)) positions, as illustrated in FIG. 8. Parameter ccsao_band_num_y may specify the band Luma. Parameter ccsao_band_num_c may specify the band chroma (cb). Parameter ccsao_band_num_u may specify the band Cb. Parameter ccsao_band_num_v may specify the band Cᵣ. Parameter ccsao_offset_abs may specify the absolute values of offset. Parameter ccsao_offset_sign may specify a sign of the value of offset.

History-based CCSAO may be implemented. There may be strong temporal correlation among the CCSAO offsets and classifier parameters of different frames. CCSAO offsets/parameters of the current frame may be stored and/or referenced for the CCSAO process of future frames. An index may be signaled in a slice header to indicate which set of stored offsets/parameters is inherited in the current slice from previous slices.

An adaptive loop filter (ALF) with block-based filter adaption may be applied, e.g., in VVC. A filter may be selected for the luma component. For example, one among 25 filters may be selected for a (e.g., each) 4×4 block. A filter may be selected, for example, based on the direction and activity of local gradients.

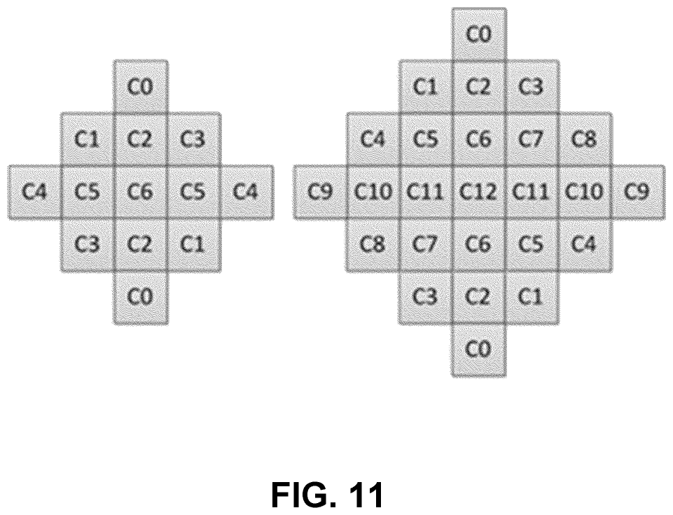

FIG. 11 illustrates an example of ALF filter shapes (e.g., chroma: 5×5 diamond, luma: 7×7 diamond). Multiple (e.g., two) diamond filter shapes (e.g., as shown in FIG. 11) may be used for ALF. As shown in FIG. 11, the 7×7 diamond shape may be applied for a luma component and/or the 5×5 diamond shape may be applied for chroma components.

Block classification may be performed. For example (e.g., for a luma component), a (e.g., each) 4×4 block may be categorized into one out of 25 classes. The classification index C may be derived, for example, based on its directionality D and a quantized value of activity Â, in accordance with Eq. (12):

$$C = 5 D + \hat{A} \qquad ( 12 )$$

Directionality D and activity Â, gradients of the horizontal, vertical, and two diagonal directions may be calculated using 1-D Laplacian, for example, in accordance with Eq. (13)-Eq. (16):

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert \qquad ( 13 )$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert \qquad ( 14 )$$

$${g}_{d 1} = {\sum }_{k = i - 2}^{i + 3} {\sum }_{l = j - 3}^{j + 3} D {1}_{k , l} , D {1}_{k , l} = \vert 2 R ( k , l ) - R ( k - 1 , l - 1 ) - R ( k + 1 , l + 1 ) \vert \qquad ( 15 )$$

$${g}_{d 2} = {\sum }_{k = i - 2}^{i + 3} {\sum }_{j = j - 2}^{j + 3} D {2}_{k , l} , D {2}_{k , l} = \vert 2 R ( k , l ) - R ( k - 1 , l + 1 ) - R ( k + 1 , l - 1 ) \vert \qquad ( 16 )$$

Indices i and j may refer to the coordinates of the upper left sample within the 4×4 block. R(i,j) may indicate a reconstructed sample at coordinate (i,j).

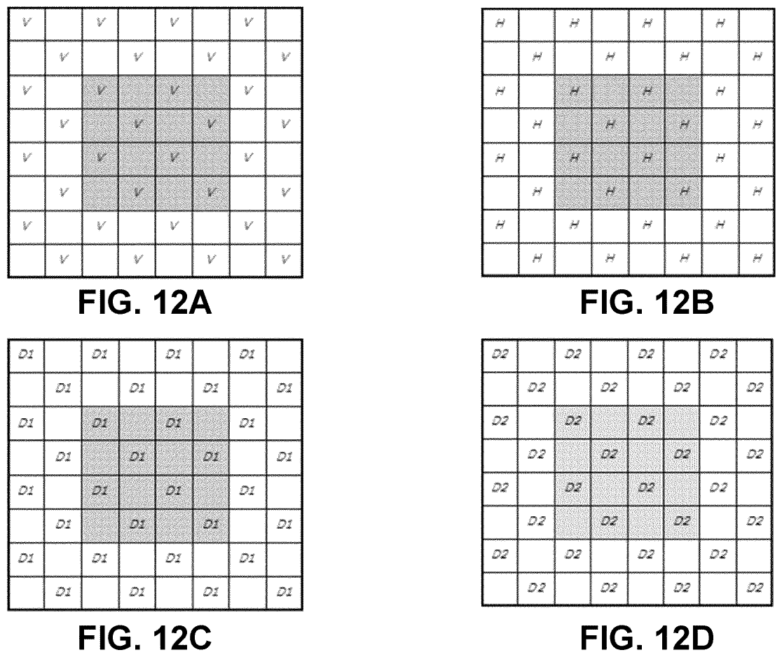

FIGS. 12A-12D illustrate examples of subsampled positions for subsampled Laplacian calculations. The complexity of block classification may be reduced, for example, by applying the subsampled 1-D Laplacian calculation. As illustrated in FIG. 12A-12D, the same subsampled positions may be used for gradient calculation of directions (e.g., all directions).

FIG. 12A illustrates an example of subsampled positions for vertical gradient for a subsampled Laplacian calculation. FIG. 12B illustrates an example of subsampled positions for horizontal gradient for a subsampled Laplacian calculation. FIG. 12C illustrates an example of subsampled positions for diagonal gradient for a subsampled Laplacian calculation. FIG. 12D illustrates an example of subsampled positions for diagonal gradient for a subsampled Laplacian calculation.

The D maximum and minimum values of the gradients of horizontal and vertical directions may be set, for example, in accordance with Eq. (17):

$${g}_{h , v}^{max} = max ( {g}_{h} , {g}_{v} ) , {g}_{h , v}^{min} = min ( {g}_{h} , {g}_{v} ) \qquad ( 17 )$$

The maximum and minimum values of the gradient of two diagonal directions may be set, for example, in accordance with Eq. (18):

$${g}_{d 0 , d 1}^{max} = max ( {g}_{d 0} , {g}_{d 1} ) , {g}_{d 0 , d 1}^{min} = min ( {g}_{d 0} , {g}_{d 1} ) \qquad ( 18 )$$

The value of the directionality D may be derived, for example, by comparing the values against each other and with two thresholds t₁ and t₂, for example, in accordance with the following logic:

$$If both {g}_{h , v}^{max} \leq {t}_{1} \cdot {g}_{h , v}^{min} and {g}_{d 0 , d 1}^{max} \leq {t}_{1} \cdot {g}_{d 0 , d 1}^{min} are true , D is set to 0.$$

$$If {g}_{h , v}^{max} / {g}_{h , v}^{min} > {g}_{d 0 , d 1}^{max} / {g}_{d 0 , d 1}^{min} , continue from Step 3 ; otherwise continue from Step 4.$$

$$If {g}_{h , v}^{max} > {t}_{2} \cdot {g}_{h , v}^{min} , D is set to 2 ; otherwise D is set to 1.$$

$$If {g}_{d 0 , d 1}^{max} > {t}_{2} \cdot {g}_{d 0 , d 1}^{min} , D is set to 4 ; otherwise D is set to 3.$$

The activity value A may be calculated, for example, in accordance with Eq. (19):

$$A = {\sum }_{k = i - 2}^{i + 3} {\sum }_{l = j - 2}^{j + 3} ( {V}_{k , l} + {H}_{k , l} ) \qquad ( 19 )$$

A may be quantized (e.g., to the range of 0 to 4, inclusively). The quantized value may be denoted as Â. For chroma components, for example, no classification may be applied.

Geometric transformations of filter coefficients and clipping values may be performed. For example, (e.g., before filtering each 4×4 luma block), geometric transformations, such as rotation or diagonal and vertical flipping, may be applied to the filter coefficients f(k, l) and/or to the corresponding filter clipping values c(k, 1), e.g., depending on gradient values calculated for the block. Performing geometric transformations of filter coefficients and/or clipping values may be equivalent to applying the transformations to the samples in the filter support region. Performing geometric transformations of filter coefficients and/or clipping values may make different blocks to which ALF is applied may be made more similar by aligning their directionality.

Multiple (e.g., three) geometric transformations, such as diagonal, vertical flip, and rotation, may be implemented, for example, in accordance with Eq. (20)-Eq. (22):

$$Diagonal \text{:} {f}_{D} ( k , l ) = f ( l , k ) , {c}_{D} ( k , l ) = c ( l , k ) \qquad ( 20 )$$

$$Vertical flip \text{:} {f}_{V} ( k , l ) = f ( k , K - l - 1 ) , {c}_{V} ( k , l ) = c ( k , K - l - 1 ) \qquad ( 21 )$$

$$Rotation \text{:} {f}_{R} ( k , l ) = f ( K - l - 1 , k ) , {c}_{R} ( k , l ) = c ( K - l - 1 , k ) \qquad ( 22 )$$

K may be the size of the filter and 0≤k, l≤K−1 are coefficients coordinates, for example, such that location (0,0) is at the upper left corner and location (K−1, K−1) is at the lower right corner. The transformations may be applied to the filter coefficients f (k, l) and/or to the clipping values c(k, l), e.g., depending on gradient values calculated for the block. The relationship between the transformation and the four gradients of the four directions may be summarized, for example, in accordance with Table 1.

TABLE 1
Example of mapping a gradient calculated
for a block and transformations

| Gradient values | Transformation |
|---|---|
| g_{d2} < g_{d1} and gₕ < gᵥ | No transformation |
| g_{d2} < g_{d1} and gᵥ < gₕ | Diagonal |
| g_{d1} < g_{d2} and gₕ < gᵥ | Vertical flip |
| g_{d1} < g_{d2} and gᵥ < gₕ | Rotation |

Filtering may be performed by a filtering process. A (e.g., each) sample R(i,j) within the CU may be filtered at the decoder side (e.g., when ALF is enabled for a CTB), resulting in sample value R′(i,j), which may be determined in accordance with Eq. (23):

$${R}^{′} ( i , j ) = R ( i , j ) + ( ( {\sum }_{k \neq 0} {\sum }_{l \neq 0} f ( k , l ) \times K ( R ( i + k , j + l ) - R ( i , j ) , c ( k , l ) ) + 64 ) ≫ 7 ) \qquad ( 23 )$$

With reference to Eq. (23), f(k, l) may denote the decoded filter coefficients, K(x, y) may be used for clipping, and c(k, l) may denote the decoded clipping parameters. The variable k and l may vary between

$$- \frac{L}{2} and \frac{L}{2} ,$$

where L may denote the filter length. The clipping function K(x, y)=min (y, max(−y, x)), which may correspond to the function Clip3 (−y, y, x). The clipping operation may introduce non-linearity that may make ALF more efficient, for example, by reducing the impact of neighbor sample values that are too different from the current sample value.

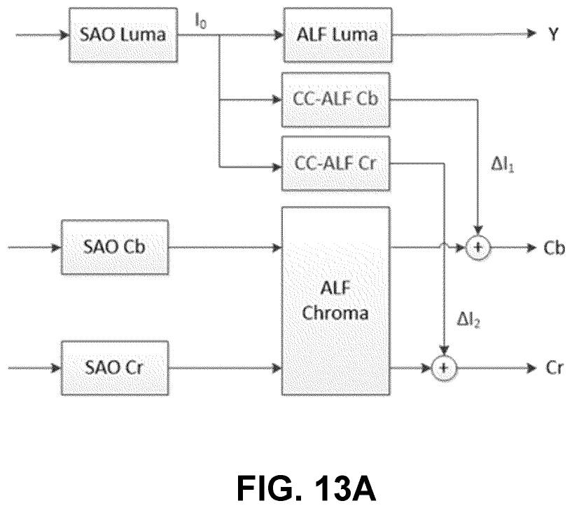

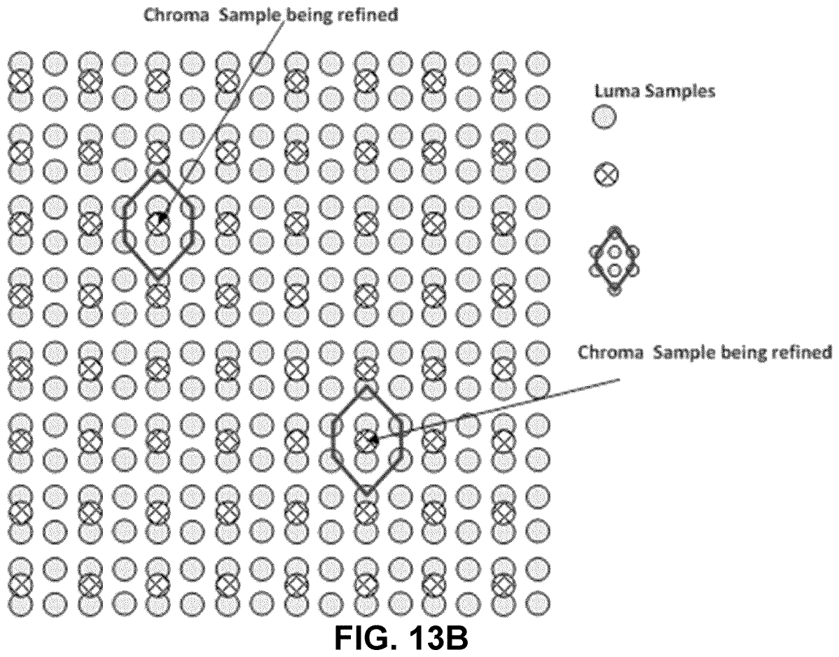

FIG. 13A is a system-level diagram illustrating an example of the CC-ALF process with respect to the SAO, luma ALF, and chroma ALF processes. A cross component adaptive loop filter (CC-ALF) may use luma sample values to refine a (e.g., each) chroma component, for example, by applying an adaptive, linear filter to the luma channel. The output of the filtering operation may be used for chroma refinement.

FIG. 13B is a diagram illustrating an example of a diamond shaped filter. Filtering in CC-ALF may be accomplished, for example, by applying a linear, diamond shaped filter (e.g., as shown by example in FIG. 13B) to the luma channel. A (e.g., one) filter may be used for a (e.g., each) chroma channel. The operation may be expressed, for example, in accordance with Eq. (24):

$$Δ {I}_{i} ( x , y ) = {\sum }_{( {x}_{0 ,} {y}_{0} ) ∈ {S}_{i}} {I}_{0} ( {x}_{Y} + {x}_{0} , {y}_{Y} + {y}_{0} ) {c}_{i} ( {x}_{0} , {y}_{0} ) \qquad ( 24 )$$

With reference to Eq. (24), (x, y) may be a chroma component i location being refined, (x_{Y}, y_{Y}) may be a luma location based on (x, y),Sᵢ may be a filter support area in a luma component, and cᵢ(x₀, y₀) may represent the filter coefficients.

As shown in FIGS. 13A and 13B, the luma filter support may be the region collocated with the current chroma sample, e.g., after accounting for the spatial scaling factor between the luma and chroma planes. FIG. 13A illustrates an example of placement of CC-ALF with respect to other loop filters. FIG. 13B illustrates an example of a diamond shaped filter.

CC-ALF filter coefficients may be computed (e.g., in VVC reference software), for example, by minimizing the mean square error of a (e.g., each) chroma channel with respect to the original chroma content, which may be achieved by a VVC test model (VTM) algorithm that uses a coefficient derivation process similar to the coefficient derivation process used for chroma ALF. For example, a correlation matrix may be derived, and the coefficients may be computed using a Cholesky decomposition solver in an attempt to minimize a mean square error metric. In some examples, a maximum of eight (8)CC-ALF filters may be designed and transmitted per picture. The resulting filters may be indicated, for example, for each of two chroma channels on a CTU basis.

CC-ALF implementations may include one or more of the following (e.g., additional) characteristics: a CC-ALF design may use a 3×4 diamond shape with 8 taps; seven filter coefficients may be transmitted in the APS; a (e.g., each) transmitted coefficient may have a 6-bit dynamic range and/or may be restricted to power-of-2 values; the eighth filter coefficient may be derived at the decoder (e.g., such that the sum of the filter coefficients is equal to 0); an APS may be referenced in the slice header; CC-ALF filter selection may be controlled at the CTU-level for a (e.g., each) chroma component; and/or boundary padding for the horizontal virtual boundaries may use the same memory access pattern as luma ALF.

A reference encoder may be configured to enable (e.g., subjective) tuning through the configuration file. The VTM may (e.g., when enabled) attenuate the application of CC-ALF in regions that are coded with high QP and/or are either near mid-grey or include an (e.g., a large) amount of luma high frequencies, which may be accomplished (e.g., algorithmically) by disabling the application of CC-ALF in CTUs where one or more of the following conditions are true: the slice QP value minus 1 is less than or equal to the base QP value; the number of chroma samples for which the local contrast is greater than (1<<(bitDepth−2))−1 exceeds the CTU height, where the local contrast may be the difference between the maximum and minimum luma sample values within the filter support region; and/or more than a number or percentage (e.g., a quarter) of chroma samples are in the range between (1<<(bitDepth−1))−16 and (1<<(bitDepth−1))+16.

The functionality may provide some (e.g., probability of) assurance that CC-ALF does not amplify artifacts introduced earlier in the decoding path (e.g., due at least in part to a lack of explicitly optimizing for chroma subjective quality in VTM). Some encoder implementations may not use one or more functionalities as described herein, or may incorporate alternative strategies suitable for their encoding characteristics.

Filter parameters may be signaled. ALF filter parameters may be signaled in an adaptation parameter set (APS). In some examples, an APS may include up to 25 sets of luma filter coefficients and clipping value indexes, and up to eight (8) sets of chroma filter coefficients and clipping value indexes. Filter coefficients of different classifications for luma components may be merged, for example, to reduce bits overhead. Indices of the APSs used for the current slice may be signaled, for example, in a slice header.

Clipping value indexes, which may be decoded from the APS, may allow determination of clipping values, for example, using a table of clipping values for (e.g., both) luma and/or chroma components. The clipping values may be dependent of the internal bitdepth. The clipping values may be obtained, for example, in accordance with Eq. (25):

$$AlfClip = \{ round ( {2}^{B - a * n} ) for n ∈ [ 0 … N - 1 ] \} \qquad ( 25 )$$

With reference to Eq. (25), B may be equal to the internal bitdepth, a may be a (e.g., pre-defined constant) value (e.g., equal to 2.35), and N may be equal to the number of allowed clipping values (e.g., 4 in VVC). The AlfClip may be rounded to the nearest value, e.g., a value with the format of power of two (2).

Multiple (e.g., up to seven (7)) APS indices may be signaled in a slice header to specify the luma filter sets that are used for the current slice. The filtering process may be (e.g., further) controlled at CTB level. A flag may (e.g., always) be signaled to indicate whether ALF is applied to a luma CTB. A luma CTB may choose a filter set among multiple (e.g., 16) fixed filter sets and/or the filter sets from APSs. A filter set index may be signaled for a luma CTB to indicate which filter set is applied. The multiple (e.g., 16) fixed filter sets may be pre-defined and/or hard-coded in the encoder and/or the decoder.

An APS index may be signaled in a slice header for chroma components to indicate the chroma filter sets being used for the current slice. A filter index may be signaled at CTB level for each chroma CTB, for example, if there is more than one chroma filter set in the APS.

Filter coefficients may be quantized, for example, with norm equal to 128. Multiplication complexity may be reduced. For example, a bitstream conformance may be applied so that the coefficient value of the non-central position is in a range (e.g., in the range of −27 to 27-1, inclusive). The central position coefficient may not be signaled in the bitstream. The central position coefficient may be (e.g., considered as) equal to 128.

Flags and parameters may be transmitted, for example, in accordance with the following logic. A picture parameter set (PPS) may be transmitted, for example, in accordance with the following:

If !pps_no_pic_partition_flag
pps_alf_info_in_ph_flag

A sequence parameter set (SPS) may be transmitted, for example, in accordance with the following:

sps_alf_enabled_flag
if sps_alf_enabled_flag && SPS Chromat format != 400
sps_ccalf_enabled_flag

A picture header may be transmitted, for example, in accordance with the following:

```
  if sps_alf_enabled_flag
      if pps_alf_info_in_ph_flag
      ph_alf_enabled_flag
      if ph_alf_enabled_flag
        ph_alf_fixed_filter_set_idx
        ph_num_alf_aps_ids_luma
        ph_num_alf_aps_ids_luma
        for ph_num_alf_aps_ids_luma
          ph_alf_aps_id_luma
if Chroma Format Idc in SPS != CHROMA_400
  ph_alf_cb_enabled_flag
  ph_alf_cr_enabled_flag
if alf chroma idc
  ph_alf_aps_id_chroma
if CCALF Cb Enabled in SPS
  ph_cc_alf_cb_enabled_flag
  if CCALF Cb Enable in Picture Header
    ph_cc_alf_cb_aps_id
  ph_cc_alf_cr_enabled_flag
  if CCALF Cr Enable in Picture Header
    ph_cc_alf_cr_aps_id
```

A slice header may be transmitted, for example, in accordance with the following logic:

```
if sps_alf_enabled_flag && !pps_alf_info_in_ph_flag
  slice_alf_enabled_flag
  if slice_alf_enabled_flag
    slice_alf_fixed_filter_set_idx
    slice_num_alf_aps_ids_luma
    for i<slice_num_alf_aps_ids_luma
      slice_alf_aps_id_luma[i]
    if chroma enabled
      slice_alf_cb_enabled_flag
      slice_alf_cr_enabled_flag
    if alf chroma idc
      slice_alf_aps_id_chroma
    if sps_ccalf_enabled_flag
      slice_cc_alf_cb_enabled_flag
      if slice_cc_alf_cb_enabled_flag
        slice_cc_alf_cb_aps_id
      slice_cc_alf_cr_enabled_flag
      if slice_cc_alf_cr_enabled_flag
        slice_cc_alf_cr_aps_id
```

An APS may be transmitted, for example, in accordance with the following logic:

aps_params_type
adaptation_parameter_set_id
aps_chroma_present_flag
...

A deblock filtering (DBF) process may be applied on CU boundaries, transform subblock boundaries, and/or prediction subblock boundaries. Prediction subblock boundaries may include prediction unit boundaries introduced by SbTMVP and affine modes. Transform subblock boundaries may include transform unit boundaries introduced by SBT and ISP modes, and/or transforms due to (e.g., implicit) split of large CUs. In HEVC, the processing order of the deblocking filter may be defined as horizontal filtering for vertical edges for a picture (e.g., the entire picture first) and (e.g., followed by) vertical filtering for horizontal edges. A processing order may enable multiple horizontal filtering or vertical filtering processes to be applied in parallel threads, or may be implemented on a CTB-by-CTB basis (e.g., with a small processing latency).

Deblocking (e.g., deblocking in WC) may implement one or more of the following. Deblocking may implement a deblocking filter with a filter strength dependent on the averaged luma level of the reconstructed samples. Deblocking may implement a deblocking tC table extension and/or adaptation to 10-bit video. Deblocking may implement 4×4 grid deblocking for luma. WC deblocking may implement a stronger deblocking filter for luma. Deblocking may implement a stronger deblocking filter for chroma. WC deblocking may implement a deblocking filter for a subblock boundary. Deblocking may adapt a deblocking decision to a smaller difference in motion.

Deblock filtering parameters may be transmitted in a header, for example, based on the following logic. PPS may be transmitted in a header, for example, based on the following logic:

```
pps_deblocking_filter_control_present_flag
if pps_deblocking_filter_control_present_flag
  pps_deblocking_filter_override_enabled_flag
  pps_deblocking_filter_disabled_flag
  if !pps_no_pic_partition_flag &&
  pps_deblocking_filter_override_enabled_flag
    pps_dbf_info_in_ph_flag
  if !pps_deblocking_filter_disabled_flag
    pps_luma_beta_offset_div2
    pps_luma_tc_offset_div2
    if pps_chroma_tool_offsets_present_flag
      pps_cb_beta_offset_div2
      pps_cb_tc_offset_div2
      pps_cr_beta_offset_div2
      pps_cr_tc_offset_div2
```

A pps_deblocking_filter_control_present_flag (e.g., equal to 1) may specify the presence of deblocking filter control syntax elements in the PPS. A pps_deblocking_filter_control_present_flag (e.g., equal to 0) may specify the absence of deblocking filter control syntax elements in the PPS and/or that the deblocking filter is applied for (e.g., all) slices referring to the PPS, using 0-valued deblocking p and to offsets.

A pps_deblocking_filter_override_enabled_flag (e.g., equal to 1) may specify that the deblocking behavior for pictures referring to the PPS could be overridden in the picture level or slice level. A pps_deblocking_filter_override_enabled_flag (e.g., equal to 0) may specify that the deblocking behavior for pictures referring to the PPS is not overridden in the picture level or slice level. The value of pps_deblocking_filter_override_enabled_flag (e.g., when not present) may be inferred (e.g., to be equal to 0).

A pps_deblocking_filter_disabled_flag (e.g., equal to 1) may specify that the deblocking filter is disabled for pictures referring to the PPS unless overridden for a picture or slice by information present the PH or SH, respectively. A pps_deblocking_filter_disabled_flag (e.g., equal to 0) may specify that the deblocking filter is enabled for pictures referring to the PPS unless overridden for a picture or slice by information present the PH or SH, respectively. The value of pps_deblocking_filter_disabled_flag may be inferred (e.g., to be equal to 0), for example, when the flag is not present.

A pps_dbf_info_in_ph_flag (e.g., equal to 1) may specify that deblocking filter information is present in the PH syntax structure and not present in slice headers referring to the PPS that do not include a PH syntax structure. A pps_dbf_info_in_ph_flag (e.g., equal to 0) may specify that deblocking filter information is not present in the PH syntax structure and could be present in slice headers referring to the PPS. The value of pps_dbf_info_in_ph_flag may be inferred (e.g., to be equal to 0), for example, when the flag is not present.

A pps_luma_beta_offset_div2 and a pps_luma_tc_offset_div2 may specify the default deblocking parameter offsets for β and tC (e.g., divided by 2) that are applied to the luma component for slices referring to the PPS, for example, unless the default deblocking parameter offsets are overridden by the deblocking parameter offsets present in the picture headers and/or the slice headers of the slices referring to the PPS. The values of pps_luma_beta_offset_div2 and pps_luma_tc_offset_div2 may be in a range (e.g., in the range of −12 to 12, inclusive). The values of pps_luma_beta_offset_div2 and/or pps_luma_tc_offset_div2 may be inferred (e.g., to be equal to 0), for example, when they not present.

A pps_cb_beta_offset_div2 and a pps_cb_tc_offset_div2 may specify the default deblocking parameter offsets for β and tC (e.g., divided by 2) that are applied to the Cb component for slices referring to the PPS, for example, unless the default deblocking parameter offsets are overridden by the deblocking parameter offsets present in the picture headers and/or the slice headers of the slices referring to the PPS. The values of pps_cb_beta_offset_div2 and pps_cb_tc_offset_div2 may be in a range (e.g., in the range of −12 to 12, inclusive). The values of pps_cb_beta_offset_div2 and/or pps_cb_tc_offset_div2 may be inferred (e.g., to be equal to pps_luma_beta_offset_div2 and pps_luma_tc_offset_div2, respectively), for example, when they are not present.

A pps_cr_beta_offset_div2 and a pps_cr_tc_offset_div2 may specify the default deblocking parameter offsets for β and tC (e.g., divided by 2) that are applied to the Cr component for slices referring to the PPS, for example, unless the default deblocking parameter offsets are overridden by the deblocking parameter offsets present in the picture headers and/or the slice headers of the slices referring to the PPS. The values of pps_cr_beta_offset_div2 and pps_cr_tc_offset_div2 may be in a range (e.g., in the range of −12 to 12, inclusive). The values of pps_cr_beta_offset_div2 and/or pps_cr_tc_offset_div2 may be inferred (e.g., to be equal to pps_luma_beta_offset_div2 and pps_luma_tc_offset_div2, respectively) when they are not present.

A picture header may be determined and/or transmitted, for example, based on the following logic:

```
if pps_dbf_info_in_ph_flag
  ph_deblocking_params_present_flag
  if ph_deblocking_params_present_flag
    if !pps_deblocking_filter_disabled_flag
      ph_deblocking_filter_disabled_flag
    if !ph_deblocking_filter_disabled_flag
      ph_luma_beta_offset_div2
      ph_luma_tc_offset_div2
      if pps_chroma_tool_offsets_present_flag
      ph_cb_beta_offset_div2
      ph_cb_tc_offset_div2
      ph_cr_beta_offset_div2
      ph_cr_tc_offset_div2
```

A ph_deblocking_params_present_flag (e.g., equal to 1) may specify that the deblocking parameters could be present in the PH syntax structure. A ph_deblocking_params_present_flag (e.g., equal to 0) may specify that the deblocking parameters are not present in the PH syntax structure. The value of ph_deblocking_params_present_flag may be inferred (e.g., to be equal to 0), for example, when not present.

A ph_deblocking_filter_disabled_flag (e.g., equal to 1) may specify that the deblocking filter is disabled for the current picture. A ph_deblocking_filter_disabled_flag (e.g., equal to 0) may specify that the deblocking filter is enabled for the current picture.

A ph_luma_beta_offset_div2 and a ph_luma_tc_offset_div2 may specify the deblocking parameter offsets for β and tC (e.g., divided by 2) that are applied to the luma component for the slices in the current picture. The values of ph_luma_beta_offset_div2 and/or ph_luma_tc_offset_div2 may be in a range (e.g., in the range of −12 to 12, inclusive). The values of ph_luma_beta_offset_div2 and/or ph_luma_tc_offset_div2 may be inferred (e.g., to be equal to pps_luma_beta_offset_div2 and pps_luma_tc_offset_div2, respectively), for example, when not present.

A ph_cb_beta_offset_div2 and a ph_cb_tc_offset_div2 may specify the deblocking parameter offsets for β and tC (e.g., divided by 2) that are applied to the Cb component for the slices in the current picture. The values of ph_cb_beta_offset_div2 and/or ph_cb_tc_offset_div2 may be in a range (e.g., in the range of −12 to 12, inclusive).

A ph_cr_beta_offset_div2 and a ph_cr_tc_offset_div2 may specify the deblocking parameter offsets for β and tC (divided by 2) that are applied to the Cᵣ component for the slices in the current picture. The values of ph_cr_beta_offset_div2 and/or ph_cr_tc_offset_div2 may be in a range (e.g., in the range of −12 to 12, inclusive).

A slice header may be determined and/or transmitted, for example, based on the following logic:

```
if( pps_deblocking_filter_override_enabled_flag &&
!pps_dbf_info_in_ph_flag )
  sh_deblocking_params_present_flag
if( sh_deblocking_params_present_flag )
  if( !pps_deblocking_filter_disabled_flag )
    sh_deblocking_filter_disabled_flag
  if( !sh_deblocking_filter_disabled_flag )
    sh_luma_beta_offset_div2
    sh_luma_tc_offset_div2
    if( pps_chroma_tool_offsets_present_flag )
      sh_cb_beta_offset_div2
      sh_cb_tc_offset_div2
      sh_cr_beta_offset_div2
      sh_cr_tc_offset_div2
```

A sh_deblocking_params_present_flag (e.g., equal to 1) may specify that the deblocking parameters could be present in the slice header. A sh_deblocking_params_present_flag (e.g., equal to 0) may specify that the deblocking parameters are not present in the slice header. The value of sh_deblocking_params_present_flag may be inferred (e.g., to be equal to 0), for example, when not present.

A sh_deblocking_filter_disabled_flag (e.g., equal to 1) may specify that the deblocking filter is disabled for the current slice. The sh_deblocking_filter_disabled_flag (e.g., equal to 0) may specify that the deblocking filter is enabled for the current slice.

A sh_luma_beta_offset_div2 and a sh_luma_tc_offset_div2 may specify the deblocking parameter offsets for β and tC (e.g., divided by 2) that are applied to the luma component for the current slice. The values of sh_luma_beta_offset_div2 and/or sh_luma_tc_offset_div2 may be in a range (e.g., in the range of −12 to 12, inclusive). The values of sh_luma_beta_offset_div2 and/or sh_luma_tc_offset_div2 may be inferred (e.g., to be equal to ph_luma_beta_offset_div2 and ph_luma_tc_offset_div2, respectively), for example, when not present.

A sh_cb_beta_offset_div2 and a sh_cb_tc_offset_div2 may specify the deblocking parameter offsets for β and tC (e.g., divided by 2) that are applied to the Cb component for the current slice.

Ash_cr_beta_offset_div2 and a sh_cr_tc_offset_div2 may specify the deblocking parameter offsets for β and tC (e.g., divided by 2) that are applied to the Cᵣ component for the current slice. The values of sh_cr_beta_offset_div2 and/or sh_cr_tc_offset_div2 may be in a range (e.g., in the range of −12 to 12, inclusive).

A post-filter order may be generated and signaled. Signaling a post-filter order may specify an order (e.g., the correct order) at the encoder and decoder for post processing. A post processing order may be stored (e.g., in dedicated code) in a header. In some examples, the post processing order may be stored in a slice header. In some examples, the post processing order may be stored in a picture header.

A post processing order may be encoded, for example, using exponential Golomb code. An example of an Exponential Golomb Code for the post filters order may be:

$$0 ⇒ 1 ⇒ 1 DBF -> SAO -> CCSAO -> ALF$$

$$1 ⇒ 10 ⇒ 010 DBF -> CCSAO -> SAO -> ALF$$

$$2 ⇒ 11 ⇒ 011 SAO -> CCSAO -> DBF -> ALF$$

$$3 ⇒ 100 ⇒ 00100 CCSAO -> SAO -> DBF -> ALF$$

$$…$$

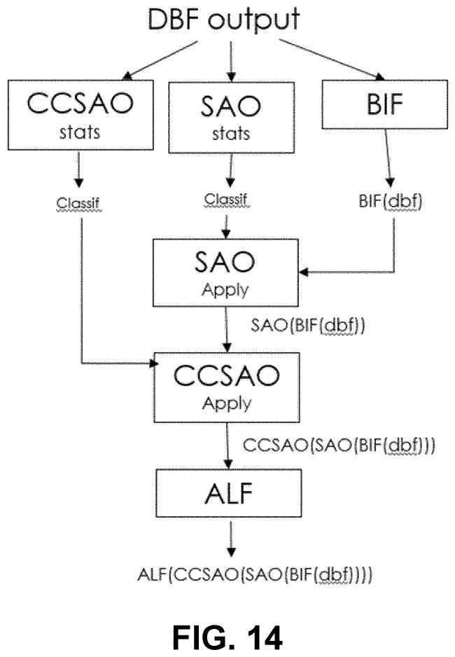

In an example, the post processing order may be implemented as depicted in FIG. 14. As illustrated in FIG. 14, a post-processing order may include computation of SAO, bilateral filter (BIF), and/or CCSAO. The SAO may be applied (e.g., applied before) CCSAO. Each of the SAO and CCSAO offsets may be applied as described herein. After CCSAO, ALF may be applied as described herein.

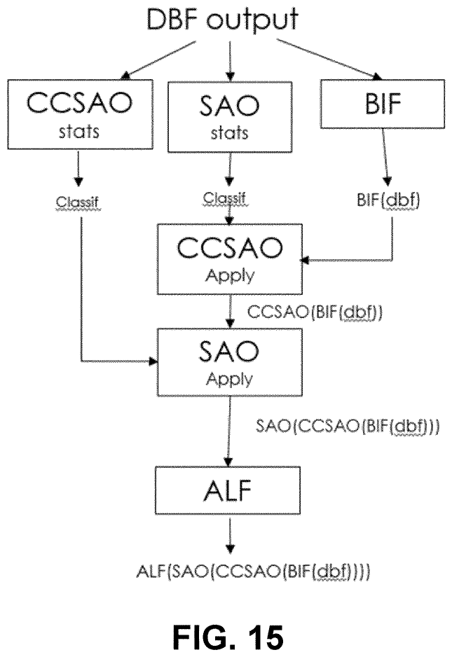

In an example, the post processing order may be implemented as depicted in FIG. 15. As illustrated in FIG. 15, SAO, bilateral filter (BIF), and/or CCSAO may be computed. The CCSAO may then be applied (e.g., applied before SAO). Each of the CCSAO and SAO offsets may be applied as described herein. Finally, ALF may be applied as described herein.

The post processing order may be stored in a region header (e.g., a slice header) or a picture header, for example. At the encoder side, a (e.g., each) post processing order may generate a coding cost and distortion. A better cost/distortion trade-off may provide a better (e.g., the best) order. A rate distortion optimizer may perform the optimization.

Examples are provided herein for storing the processing order in a picture header and/or in a slice header.

A processing order may be stored in a picture header. In some examples, a Luma post-filtering order may be applied similarly to chroma. In some examples, there may be a different order for luma and chroma. For example:

$$ph\_postproc \_order = rdo\_postprocessing \_order \_picture ( )$$

A picture header may indicate a processing order, for example, according to the following logic and/or syntax:

```
if sps_sao_enabled_flag && pps_sao_info_in_ph_flag :
    ph_sao_luma_enabled_flag
      ...
  if sps_ccsao_enabled_flag enable && pps_sao_info_in_ph_flag :
      ph_cc_sao_y_enabled_flag
      ...
  if pps_dbf_info_in_ph_flag
      ph_deblocking_params_present_flag
      ...
  if sps_alf_enabled_flag
      if pps_alf_info_in_ph_flag
        ph_alf_enabled_flag
          ...
  ph_postproc_order
```

rdo_postprocessing_order_picture ( ) may return an order (e.g., the best order) for luma. An order, for example, the best oarder for luma may be implemented as follows:

| | |
|---|---|
| postfilter[4,4] = | {{dbf( ),sao( ),ccsao( ),alf( )}, |
| | {dbf( ),ccsao( ),sao( ),alf( )}, |
| | {sao( ),ccsao( ),dbf( ),alf( )}, |
| | {ccsao( ),sao( ),dbf( ),alf( )}, |
| | ...... |
| | } |
| k = 0 ⇒ 1 ⇒ 1 | DBF->SAO->CCSAO->ALF |
| k = 1 ⇒ 10 ⇒ 010 | DBF->CCSAO->SAO->ALF |
| k = 2 ⇒ 11 ⇒ 011 | SAO->CCSAO->DBF->ALF |
| k = 3 ⇒ 100 ⇒ 00100 | CCSAO->SAO->DBF->ALF |

```
...
  rdo_postprocessing_order_picture (Picture)
      For each k
        Picture₀, cost₀,psnr₀ = postfilter[k,0](Picture)
        Picture₁, cost₁,psnr₁ = postfilter[k,1](Picture1)
        Picture₂, cost₂,psnr₂ = postfilter[k,2](Picture2)
        Picture₃, cost₃,psnr₃ = postfilter[k,3](Picture3)
        costRD[k] = cost_rd(Σᵢ₌₀³ costᵢ,psnr₃)
        k=k+1
      best_order = argminₖ(costRD[k])
      return best_order
```

The rate distortion (RD) cost of a candidate block may be determined or computed by an encoder. The RD cost may be calculated, for example, in accordance with Eq. (26):

$$CostRD = D + Lambda ( QP ) R \qquad ( 26 )$$

With reference to Eq. (26), D may be the distortion (e.g., L2, such as mean square error, peak signal-to-noise ratio (PSNR)) of a current block with its coding parameters. R may be the associated rate or cost (e.g., in number of coding bits). Lambda(QP) may be the Lagrange parameter deduced from the quantization parameter (QP). The costRD may be computed for (e.g., all) CTUs of a picture.

A processing order may be stored in a slice header. The Luma order may be applied to chroma. Processing orders considered for luma may be different from the ones considered for chroma. For example:

$$sh\_postproc \_order = rdo\_postprocessing \_order \_slice ( )$$

A slice header may indicate a processing order, for example, according to the following logic and/or syntax:

```
if pps_sao_info_in_ph_flag && !sps_sao_enabled_flag
  slice_sao_luma_flag
  ...
if sps_ccsao_enabled_flag enable
      slice_ccsao_y_enabled_flag
      slice_ccsao_cr_enabled_flag
      slice_ccsao_cb_enabled_flag
...
  if sps_alf_enabled_flag && !pps_alf_info_in_ph_flag
    slice_alf_enabled_flag
  ...
if( pps_deblocking_filter_override_enabled_flag &&
!pps_dbf_info_in_ph_flag )
        sh_deblocking_params_present_flag
....
sh_postproc_order
```

rdo_postprocessing_order_slice ( ) may be used to compute or obtain an order (e.g., the best order) for luma. An example algorithm may be implemented as follows:

| postfilter[4,4] = {{dbf( ),sao( ),ccsao( ),alf( )}, | |
|---|---|
| | {dbf( ),ccsao( ),sao( ),alf( )}, |
| | {sao( ),ccsao( ),dbf( ),alf( )}, |
| | {ccsao( ),sao( ),dbf( ),alf( )}, |
| | ...... |
| | } |
| k = 0 ⇒ 1 ⇒ 1 | DBF->SAO->CCSAO->ALF |
| k = 1 ⇒ 10 ⇒ 010 | DBF->CCSAO->SAO->ALF |
| k = 2 ⇒ 11 ⇒ 011 | SAO->CCSAO->DBF->ALF |
| k = 3 ⇒ 100 ⇒ 00100 | CCSAO->SAO->DBF->ALF |

```
...
  rdo_postprocessing_order_slice (Slice)
      For each k
        Picture₀, cost₀,psnr₀ = postfilter[k,0](Picture)
        Picture₁, cost₁,psnr₁ = postfilter[k,1](Picture1)
        Picture₂, cost₂,psnr₂ = postfilter[k,2](Picture2)
        Picture₃, cost₃,psnr₃ = postfilter[k,3](Picture3)
        costRD[k] = cost_rd(Σᵢ₌₀³ costᵢ,psnr₃)
        k=k+1
      best_order = argminₖ(costRD[r])
      return best_order
```

The rate distortion (RD) cost of a candidate block is a function that may be computed by the encoder. The RD cost of a candidate block may be calculated, for example, in accordance with Eq. (27):

$$CostRD = D + Lambda ( QP ) R \qquad ( 27 )$$

With reference to Eq. (27), D may be the distortion (e.g., L2, such as mean square error, PSNR) of the current block with its coding parameters. R may be the associated rate or cost (e.g., in number of coding bits). Lambda(QP) may be the Lagrange parameter deduced from the quantization parameter QP. The costRD may be computed for (e.g., all) CTUs of the slice.

In some examples, other levels of signaling may be performed. For example, a post processing order (e.g., postproc_order) may (e.g., also) be signaled at a picture parameter set (PPS) level. The RDO at the encoder side may be performed, for example, as in the case of signaling at the picture header level.

In some examples, a postproc_order syntax element may be inferred (e.g., to a default value), rather than signaled. For example, a postproc_order syntax element may be inferred instead of signaled to a default value if (e.g., only) one post filter is activated. For example, a postproc_order syntax element may be inferred instead of signaled to a default value if DBF is activated together with another (e.g., only one other) post filter, where DBF may be processed first.

In some examples, DBF (e.g., if activated) may (e.g., always) be processed first. The number of combinations may be lower when DBF is processed first, which may save signaling and encoder processing power.

In some examples, a syntax element postproc_order_change may be signaled before postproc_order. The postproc_order_change set at a first value (e.g., 0) may indicate a default order is used (e.g., DBF, SAO, CCSAO, and ALF). Otherwise, postproc_order may be signaled to change the processing order. The value/indication of postproc_order_change may be inferred (e.g., to be 0), for example, if one or zero loop filters are activated (e.g., or one or zero loop filters plus DBF).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-48. (canceled)

49. A video encoding device comprising a processor configured to:
generate a coding cost and a distortion associated with each of a plurality of post-filter orders of at least two filters;
based on the coding cost and the distortion, select a post-filter order from the plurality of post-filter orders, wherein the selected post-filter order is associated with a sub-region of a region or a picture, and wherein the selected post-filter order indicates a post-filter processing order; and
send the selected post-filter order in a region header or a picture header.

50. The video encoding device of claim 49, wherein the processor is further configured to determine a luma post-filter order or a chroma post-filter order.

51. The video encoding device of claim 49, wherein the processor is further configured to:
determine a luma post-filter order; and
apply the luma post-filter order to a chroma post-filter order.

52. The video encoding device of claim 51, wherein the luma post-filter order is different than the chroma post-filter order.

53. The video encoding device of claim 49, wherein the processor is further configured to:
when the post-filter order is to be sent to the region header, determine a rate distortion cost for the sub-region of the region.

54. The video encoding device of claim 49, wherein the processor is further configured to:
when the post-filter order is to be sent to the picture header, determine a rate distortion cost for a sub-region of the picture.

55. The video encoding device of claim 54, wherein the processor is further configured to:
determine the rate distortion cost based on a distortion of a current block with a coding parameter of the current block, an associated rate or cost, and a parameter derived from a quantization parameter.

56. The video encoding device of claim 49, wherein the sub-region is a coding tree unit (CTU), the region is a slice, and the region header is a slice header.

57. The video encoding device of claim 49, wherein the at least two filters comprises a sample-adaptive offset (SAO), a cross-component SAO (CCSAO), an adaptive loop filter, or a deblocking filter.

58. The video encoding device of claim 49, wherein the post-filter order indicates that a CCSAO is to be applied before a SAO.

59. A method for video encoding comprising:
generating a coding cost and a distortion associated with each of a plurality of post-filter orders of at least two filters;
based on the coding cost and the distortion, selecting a post-filter order from the plurality of post-filter orders, wherein the selected post-filter order is associated with a sub-region of a region or a picture, and wherein the selected post-filter order indicates a post-filter processing order; and
sending the selected post-filter order in a region header or a picture header.

60. The method of claim 59, wherein the method further comprises determining a luma post-filter order or a chroma post-filter order.

61. The method of claim 59, wherein the method further comprises:
determining a luma post-filter order; and
applying the luma post-filter order to a chroma post-filter order.

62. The method of claim 61, wherein the luma post-filter order is different than the chroma post-filter order.

63. The method of claim 59, wherein the method further comprises:
when the post-filter order is to be sent to the region header, determining a rate distortion cost for the sub-region of the region.

64. The method of claim 59, wherein the method further comprises:
when the post-filter order is to be sent to the picture header, determining a rate distortion cost for a sub-region of the picture.

65. A video decoding device comprising a processor configured to:
receive, in a region header or a picture header, an indication of a post-filter order associated with a sub-region of a region or a picture;
determine the post-filter order associated with the sub-region of the region or the picture based on the indication, wherein the post-filter order is associated with at least two filters, and wherein the post-filter order indicates a post-filter processing order; and
decode the picture using the at least two filters indicated by the post-filter processing order.

66. The video decoding device of claim 65, wherein the processor is further configured to determine a luma post-filter order or a chroma post-filter order.

67. The video decoding device of claim 65, wherein the at least two filters comprises a sample-adaptive offset (SAO), a cross-component SAO (CCSAO), an adaptive loop filter, or a deblocking filter.

68. The video decoding device of claim 65, wherein the post-filter order indicates that a CCSAO is to be applied before a SAO.
